(19) United States
(12) Patent Application Publication
(10) Pub. No.: US 2026/0360390 A1
(43) Pub. Date: Nov. 12, 2026

(54) METHOD FOR VIDEO EDITING, ELECTRONIC DEVICE, AND STORAGE MEDIUM

(71) Applicant: Beijing Zitiao Network Technology Co., Ltd., Beijing (CN)

(72) Inventors: Mengliang CHEN, Beijing (CN); Chenyu XIANG, Beijing (CN)

(21) Appl. No.: 19/515,667

(22) PCT Filed: Aug. 30, 2024
(86) PCT No.: PCT/CN2024/115690

§ 371 Date: Mar. 2, 2026

(30) Foreign Application Priority Data
Aug. 30, 2023 (CN) 202311110415.X

(51) Int. Cl. G11B 27/031; G06F 9/48

(52) U.S. Cl. CPC G11B 27/031; G06F 9/4881

(57) ABSTRACT

Provided in the embodiments of the present disclosure are a video editing method, an apparatus, a device and a storage medium. The video editing method comprises: in response to receiving an editing task to be added, determining a video clip corresponding to the editing task to be added and category information corresponding to the editing task to be added; acquiring a task list corresponding to the video clip, the task list comprising at least one added editing task; determining category information corresponding to the added editing task, and, on the basis of the category information corresponding to the editing task to be added and the category information corresponding to the added editing task, determining an execution sequence of the editing task to be added and the added editing task; and, according to the execution sequence, adding the editing task to be added into the task list, and, according to the execution sequence of the editing tasks in the task list, editing the video clip. The embodiments of the present disclosure can avoid the impact of a current task on tasks that have been executed, thus improving video editing efficiency.

The present application claims priority to Chinese Patent Application No. 202311110415.X, filed on Aug. 30, 2023, which is incorporated herein by reference in its entirety as a part of the present application.

### TECHNICAL FIELD

Embodiments of the present disclosure relate to a method for video editing and apparatus, and a device and a storage medium.

### BACKGROUND

In order to improve video display effects, videos may be edited. For example, the playing rate of a video is adjusted or anti-shaking processing is performed on a video to improve the display effect of the video.

When a video is edited, editing tasks are executed sequentially according to the adding time of the editing tasks. For example, the adding time of the editing tasks is as follows: reverse playing, slow motion and anti-shaking. In this case, reverse playing processing is performed on the video first, then slow motion processing is performed on the video, and finally anti-shaking processing is performed on the video.

However, the inventors of the present disclosure have noticed that the following technical problem exists at least: if the editing tasks are executed sequentially according to the adding time of the editing tasks, when a subsequent editing task is executed, the editing effect of a previous editing task that has been executed may be affected. In this case, the user needs to re-edit the video, which leads to low efficiency of video editing.

### SUMMARY

Embodiments of the present disclosure provide a method for video editing and apparatus, and a device and a storage medium.

In a first aspect, an embodiment of the present disclosure provides a method for video editing, including:
determining a video clip corresponding to an editing task to be added and category information corresponding to the editing task to be added in response to receiving the editing task to be added;
acquiring a task list corresponding to the video clip, where the task list includes at least one added editing task;
determining category information corresponding to the added editing task, and determining an execution sequence of the editing task to be added and the added editing task according to the category information corresponding to the editing task to be added and the category information corresponding to the added editing task; and
adding the editing task to be added to the task list according to the execution sequence, and editing the video clip according to the execution sequence of each editing task in the task list.

In a second aspect, an embodiment of the present disclosure provides a video editing apparatus, including:
a first determination module configured to determine a video clip corresponding to an editing task to be added and category information corresponding to the editing task to be added in response to receiving the editing task to be added;
an acquisition module configured to acquire a task list corresponding to the video clip, where the task list includes at least one added editing task;
a second determination module configured to determine category information corresponding to the added editing task, and determine an execution sequence of the editing task to be added and the added editing task according to the category information corresponding to the editing task to be added and the category information corresponding to the added editing task; and
an editing module configured to add the editing task to be added to the task list according to the execution sequence, and edit the video clip according to the execution sequence of each editing task in the task list.

In a third aspect, an embodiment of the present disclosure provides an electronic device, including:
a processor, and a memory communicatively connected to the processor; where the memory stores computer-executable instructions, and the processor executes the computer-executable instructions stored in the memory to implement the method for video editing according to the first aspect above.

In a fourth aspect, an embodiment of the present disclosure provides a computer-readable storage medium, where computer-executable instructions are stored in the computer-readable storage medium, and when the computer-executable instructions are executed by a processor, the method for video editing according to the first aspect above is implemented.

In a fifth aspect, an embodiment of the present disclosure provides a computer program product, including a computer program, and when the computer program is executed by a processor, the method for video editing according to the first aspect above is implemented.

### BRIEF DESCRIPTION OF DRAWINGS

In order to more clearly explain the technical solutions in the embodiments of the present disclosure, the drawings that need to be used in the description of the embodiments will be briefly introduced below. Obviously, the drawings in the following description are some embodiments of the present disclosure, and for those of ordinary skill in the art, other drawings may be obtained according to these drawings without paying any creative effort.

FIG. 1 is a schematic diagram of an application scenario of a method for video editing provided by an embodiment of the present disclosure;

FIG. 2 is a flowchart of a method for video editing provided by an embodiment of the present disclosure;

FIG. 3 is an example diagram of a method for video editing provided by an embodiment of the present disclosure;

FIG. 4 is an example diagram of another method for video editing provided by an embodiment of the present disclosure;

FIG. 5 is a flowchart of another method for video editing provided by an embodiment of the present disclosure;

FIG. 6 is an example diagram of still another method for video editing provided by an embodiment of the present disclosure;

FIG. 7 is a structural block diagram of a video editing apparatus provided by an embodiment of the present disclosure; and

FIG. 8 is a schematic hardware structural diagram of an electronic device provided by an embodiment of the present disclosure.

### DETAILED DESCRIPTION

In order to make the objectives, technical solutions and advantages of the embodiments of the present disclosure clearer, the technical solutions in the embodiments of the present disclosure will be clearly and completely described below in conjunction with the drawings in the embodiments of the present disclosure. Obviously, the described embodiments are part of the embodiments of the present disclosure, not all of them. Based on the embodiments in the present disclosure, all other embodiments obtained by those of ordinary skill in the art without paying any creative effort belong to the protection scope of the present disclosure.

It should be noted that the user information (including but not limited to user device information, user personal information, etc.) and data (including but not limited to data for analysis, stored data, displayed data, etc.) involved in this application are all information and data authorized by the user or fully authorized by all parties, and the collection, use and processing of relevant data need to comply with relevant laws, regulations and standards, and provide corresponding operation entrance for users to choose authorization or rejection.

At present, in order to improve the display effect of a video, the video may be edited. For example, the playing rate of the video is adjusted, anti-shaking processing is performed on the video, etc., so as to improve the display effect of the video.

For example, when a video is edited, editing tasks are executed sequentially according to the adding time of the editing tasks. For example, the adding time of the editing tasks is as follows: reverse playing, slow motion and anti-shaking. In this case, reverse playing processing is performed on the video first, then slow motion processing is performed on the video, and finally anti-shaking processing is performed on the video. However, if the editing tasks are executed sequentially according to the adding time of the editing tasks, when a subsequent editing task is executed, the editing effect of a previous editing task that has been executed may be affected. In this case, the user needs to re-edit the video, which leads to low efficiency of video editing.

Exemplarily, multiple editing tasks sorted by adding time are: anti-shaking and reverse playing. In this case, anti-shaking processing is performed on the video first, and then reverse playing processing is performed on the video. However, the reverse playing processing will generate a new video, and the generated new video does not have an anti-shaking effect, that is, the reverse playing processing in a latter step will affect the editing effect of the anti-shaking processing in a former step. In this case, the user needs to re-edit the video, which leads to low efficiency of video editing.

It may be seen that how to avoid the influence of a current editing task on a previous editing task that has been executed, so as to improve the efficiency of video editing is an urgent technical problem to be solved at present.

In order to solve the above problem, this embodiment provides the following technical conception: first, a video clip corresponding to an editing task to be added and category information corresponding to the editing task to be added are determined in response to receiving the editing task to be added; a task list corresponding to the video clip is acquired, where the task list includes at least one added editing task; then, category information corresponding to the added editing task is determined, and an execution sequence of the editing task to be added and the added editing task is determined according to the category information corresponding to the editing task to be added and the category information corresponding to the added editing task; and finally, the editing task to be added is added to the task list according to the execution sequence, and the video clip is edited according to the execution sequence of each editing task in the task list. When the editing task is added, the execution sequence of each editing task is first determined according to the category information, and then each editing task is executed according to the execution sequence, which may avoid the situation that the editing task to be added affects the added editing task, resulting in the failure of the executed editing task, thus improving the efficiency of video editing.

The editing method in the embodiment of the present disclosure may be applied to a scenario where various editing processes are performed on a video. The editing process may include multiple editing tasks. Optionally, the editing tasks may include one or more of slow motion, reverse playing, frame interpolation, anti-shaking, effect adding, stroboscopic effect removing and noise reduction. It should be noted that the editing tasks may be run locally by a terminal to perform editing processing on a video, or may be run by a server to perform editing processing on a video. FIG. 1 is a schematic diagram of an application scenario of a method for video editing provided by an embodiment of the present disclosure. When running through a server, as shown in FIG. 1, a terminal 101 sends a processing request for an editing task to a server 102. The processing request carries original video data; the server 102 receives the processing request from the terminal 101, and processes the original video data in the processing request to obtain new video data; the server 102 returns the new video data to the terminal 101; and the terminal 101 receives and displays the new video data. The method for video editing provided by the embodiments of the present disclosure will be described in detail below with detailed embodiments.

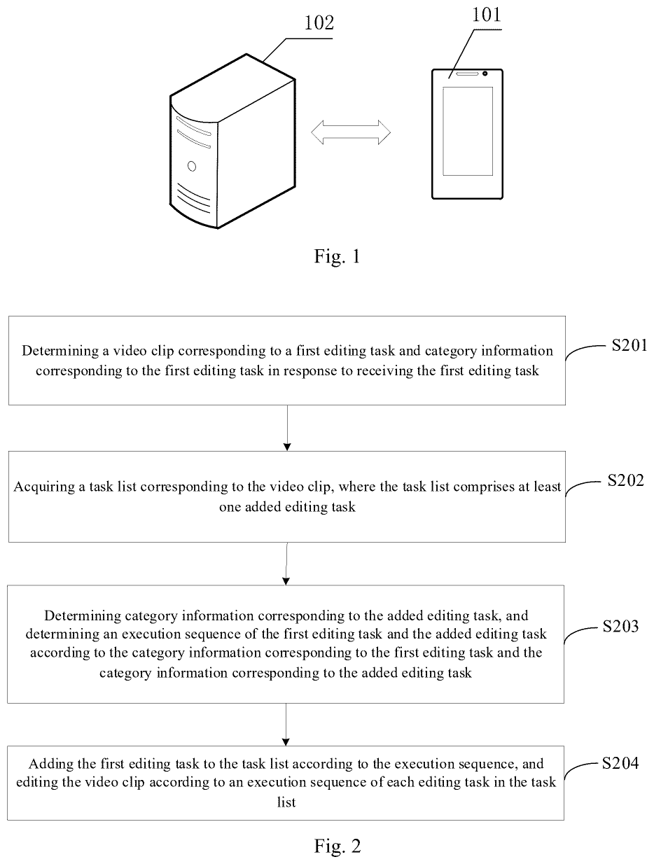

Referring to FIG. 2, FIG. 2 is a flowchart of a method for video editing provided by an embodiment of the present disclosure. The method for video editing provided by this embodiment may be applied to a terminal or a server. The embodiment of the present disclosure is described by taking the method applied to a terminal as an example. The method for video editing includes:

S201, determining a video clip corresponding to an editing task to be added and category information corresponding to the editing task to be added in response to receiving the editing task to be added.

In the embodiment of the present disclosure, during the video editing process, a video will be divided into multiple video clips, the multiple video clips will be edited separately, and the multiple edited video clips will be combined to obtain an edited video.

In some embodiments, the editing task to be added corresponding to a trigger operation may be generated through the trigger operation on a video editing interface. Optionally, multiple task controls are displayed in the video editing interface; and the editing task to be added is received in response to a trigger operation on any task control. Exemplarily, the multiple task controls displayed in the video editing interface include: “reverse playing”, “slow motion”, “keying”, “anti-shaking”, “frame interpolation”, “stroboscopic effect removing” and “noise reduction”. In response to a trigger operation on a “stroboscopic effect removing” task control, the editing task to be added received is: stroboscopic effect removing.

In some embodiments, one editing task may be used to edit one video clip or multiple video clips. Optionally, the step of determining the video clip corresponding to the editing task to be added is: determining the video clip to be a video clip to be edited in response to a selection operation on any video clip. When the user only performs the selection operation on one video clip, the editing task edits the one video clip; and when the user performs the selection operation on multiple video clips, the editing task edits the multiple video clips.

In the embodiment of the present disclosure, the category information corresponding to the editing task to be added may be determined according to whether a new video clip is obtained after processing the video clip. Optionally, if a new video clip is generated after editing the video clip through the editing task, the category information corresponding to the editing task is determined to be: a new video generation category; and if no new video clip is generated after editing the video clip through the editing task, the category information corresponding to the editing task is determined to be: an original video adjustment category.

Exemplarily, the editing tasks: reverse playing, slow motion, stroboscopic effect removing, noise reduction and frame interpolation will generate new video clips, which belong to the new video generation category; and the editing tasks: keying and anti-shaking do not generate new video clips, which belong to the original video adjustment category.

S202, acquiring a task list corresponding to the video clip, where the task list includes at least one added editing task.

In some embodiments, an association between clip identifications of video clips and task lists is stored in the terminal, and one clip identification of a video clip corresponds to one task list. Accordingly, this step may include: acquiring the task list corresponding to the video clip from the stored association between the clip identifications and the task lists according to a clip identification of the video clip.

Exemplarily, the clip identification of the video clip is: clip A; and the task list corresponding to the clip A is acquired from the stored association between the clip identifications and the task lists.

S203, determining category information corresponding to the added editing task, and determining an execution sequence of the editing task to be added and the added editing task according to the category information corresponding to the editing task to be added and the category information corresponding to the added editing task.

In the embodiment of the present disclosure, the execution sequence of the editing task to be added and the added editing task may be determined by an execution priority of each editing task. Accordingly, this step is: determining the execution priority of each editing task according to the category information corresponding to the editing task to be added and the category information corresponding to the added editing task; and determining the execution sequence of the editing task to be added and the added editing task according to the execution priority of each editing task.

In some embodiments, the category information includes a new video generation category and an original video adjustment category, and the execution priority of the new video generation category is higher than the execution priority of the original video adjustment category. Accordingly, the step of determining the execution priority of each editing task according to the category information corresponding to the editing task to be added and the category information corresponding to the added editing task includes: if the category information is the new video generation category, determining the execution priority of the editing task to be a first-level priority, and if the category information is the original video adjustment category, determining the execution priority of the editing task to be a second-level priority, where the new video generation category is used to represent that a new video clip is generated after editing the video clip through the editing task, and the original video adjustment category is used to represent that no new video clip is generated after editing the video clip through the editing task; and the first-level priority is higher than the second-level priority.

Exemplarily, the editing task received is: stroboscopic effect removing, and the first category information corresponding to the editing task is: the new video generation category, thus determining that the execution priority of the editing task “stroboscopic effect removing” is the first-level priority. The added editing tasks in the task list include: keying, reverse playing and anti-shaking. The second category information corresponding to the added editing task (keying) is: the original video adjustment category, thus determining that the execution priority of the added editing task (keying) is the second-level priority. The second category information corresponding to the added editing task (reverse playing) is: the new video generation category, thus determining that the execution priority of the added editing task (reverse playing) is the first-level priority. The second category information corresponding to the added editing task (anti-shaking) is: the original video adjustment category, thus determining that the execution priority of the added editing task (anti-shaking) is the second-level priority.

Multiple editing tasks at the same level may be sorted according to the sequence of their adding time. Accordingly, the step of determining the execution sequence of the editing task to be added and the added editing task according to the execution priority of each editing task includes: setting the execution sequence of the editing task with the first-level priority before the execution sequence of the editing task with the second-level priority; if there are multiple editing tasks with the first-level priority, acquiring the adding time of each editing task with the first-level priority, and determining the execution sequence of the multiple editing tasks with the first-level priority according to the sequence of the adding time of the editing tasks; and/or if there are multiple editing tasks with the second-level priority, acquiring the adding time of each editing task with the second-level priority, and determining the execution sequence of the multiple editing tasks with the second-level priority according to the sequence of the adding time of the editing tasks.

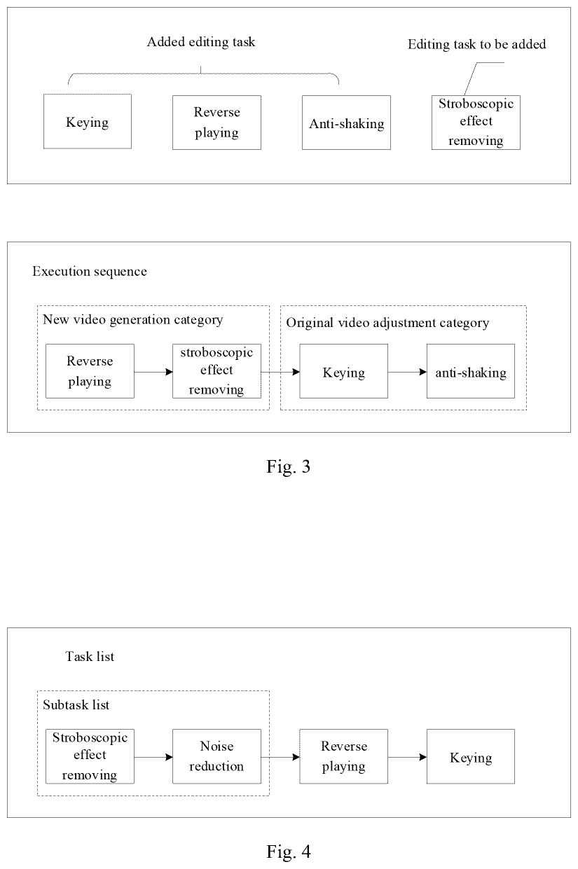

Exemplarily, as shown in FIG. 3, the editing task received is: stroboscopic effect removing (first-level priority), and the added editing tasks in the task list include: keying (second-level priority), reverse playing (first-level priority) and anti-shaking (second-level priority). Accordingly, with continued reference to FIG. 3, the execution sequence of the multiple editing tasks with the first-level priority being placed before the execution sequence of the multiple editing tasks with the second-level priority is: reverse playing (first-level priority), stroboscopic effect removing (first-level priority); and keying (second-level priority), anti-shaking (second-level priority). Sorted according to the sequence of the adding time, the execution sequence obtained is: reverse playing→stroboscopic effect removing→keying→anti-shaking.

It should be noted that the method for determining the category information corresponding to the added editing task in step S203 is the same as the method for determining the category information corresponding to the editing task to be added in step S201, which will not be repeated here.

S204, adding the editing task to be added to the task list according to the execution sequence, and editing the video clip according to the execution sequence of each editing task in the task list.

Exemplarily, as shown in FIG. 3, the editing task to be added received is: stroboscopic effect removing, and the added editing tasks in the task list include: keying, reverse playing and anti-shaking. The execution sequence is: reverse playing→stroboscopic effect removing→keying→anti-shaking. Accordingly, the editing task to be added “stroboscopic effect removing” is added between the editing tasks “reverse playing” and “keying” in the task list according to the execution sequence. The video clip is edited sequentially according to each of the editing tasks (reverse playing, stroboscopic effect removing, keying, anti-shaking) in the task list.

According to the method for video editing provided by this embodiment, a video clip corresponding to an editing task to be added and category information corresponding to the editing task to be added are determined in response to receiving the editing task to be added; a task list corresponding to the video clip is acquired, where the task list includes at least one added editing task; category information corresponding to the added editing task is determined, and an execution sequence of the editing task to be added and the added editing task is determined according to the category information corresponding to the editing task to be added and the category information corresponding to the added editing task; and the editing task to be added is added to the task list according to the execution sequence, and the video clip is edited according to the execution sequence of each editing task in the task list. When the editing task is added, the execution sequence of each editing task is first determined, then the editing task to be added is added to the task list according to the execution sequence, and each editing task is executed according to the execution sequence, which may avoid the situation that the editing task to be added affects the added editing task, resulting in the failure of the executed editing task, thus improving the efficiency of video editing.

The execution sequence of the editing task to be added and the added editing task determined in step S203 will be further described below based on the embodiment of FIG. 2 above.

In an embodiment of the present disclosure, if the received editing task affects a certain historical editing task that has been executed on the video clip, the historical editing task is automatically added to the task list. Accordingly, after the editing task to be added is added to the task list according to the execution sequence, the method further includes: acquiring the historical editing task that has been executed on the video clip, and determining whether there is a coupling relationship between the editing task to be added and the historical editing task, where the coupling relationship is used to represent that the editing task to be added will change the editing effect of the historical editing task; and if there is the coupling relationship between the editing task to be added and the historical editing task, re-adding the historical editing task to the task list. It should be noted that the historical editing task that has been executed includes: an editing task that has been processed and an editing task that is being processed.

Exemplarily, the historical editing task that has been executed on the video clip is: keying, and the editing task to be added received is: reverse playing. The editing task to be added (reverse playing) will change the editing effect of the historical editing task (keying), that is, there is a coupling relationship between the editing task to be added (reverse playing) and the historical editing task (keying). In this case, the historical editing task (keying) is added to the task list again.

Here, since the historical editing task is added to the task list if the received editing task to be added affects the certain historical editing task that has been executed on the video clip, automatic restoration of the historical editing task is realized, and the step of manual restoration is omitted, thus further improving the efficiency of editing the video.

In an embodiment of the present disclosure, if there are multiple video clips corresponding to the editing task to be added, the editing task to be added is preferentially processed. Accordingly, before the task list corresponding to the video clip is acquired, the method further includes: if there are multiple video clips corresponding to the editing task to be added, taking the editing task to be added as an initial editing task in the task list or taking the editing task to be added as a separate editing task, where the execution priority of the separate editing task is greater than the execution priority of an editing task in the task list.

Exemplarily, the editing task to be added is lyrics recognition, and the editing task is a global task, that is, lyrics recognition needs to be performed on multiple video clips. In this case, the editing task (lyrics recognition) may be executed separately or the editing task (lyrics recognition) may be taken as the initial editing task in the task list.

Here, since the editing task is preferentially processed if there are multiple video clips corresponding to the editing task to be added, the waiting time of the global task is reduced, thus further improving the efficiency of editing the video.

In an embodiment of the present disclosure, the task list may further include a subtask list, and the subtask list has a higher priority. When the editing task is added to the task list, the editing task may be added according to the execution sequence corresponding to the subtask list. Accordingly, the step of adding the editing task to be added to the task list according to the execution sequence includes: querying whether there is a target editing task whose execution sequence has a binding relationship with the execution sequence of the editing task to be added in the at least one added editing task included in the task list; and if there is the target editing task, adding the editing task to be added to an adjacent position of the target editing task according to the execution sequence indicated in the binding relationship.

Optionally, if there is the target editing task whose execution sequence has the binding relationship with the execution sequence of the editing task to be added, the editing task to be added and the target editing task may be combined into a subtask list, and the execution sequence of the multiple editing tasks in the subtask list is fixed, which may improve the editing effect of the video. For example, if the noise reduction processing is performed after the stroboscopic effect removing processing is performed on the video, the editing effect of the video may be improved, thus the stroboscopic effect removing and the noise reduction may be bound, and the binding relationship may be stored to obtain the subtask list.

Exemplarily, as shown in FIG. 4, the task list includes: stroboscopic effect removing, reverse playing and keying, and if the editing task received is: noise reduction, it is determined that there is a binding relationship between the execution sequences of the noise reduction and the stroboscopic effect removing, and the corresponding subtask list is: stroboscopic effect removing→noise reduction. The editing task is added to an adjacent position of the target editing task according to the execution sequence indicated in the binding relationship. The execution sequence corresponding to the finally obtained task list is: stroboscopic effect removing→noise reduction→reverse playing→keying.

Here, when the editing task is added to the task list, the editing task may be added according to the execution sequence corresponding to the subtask list, and the execution sequence of the multiple editing tasks in the subtask list has a binding relationship, which may improve the editing effect of the video, thus further improving the efficiency of editing the video.

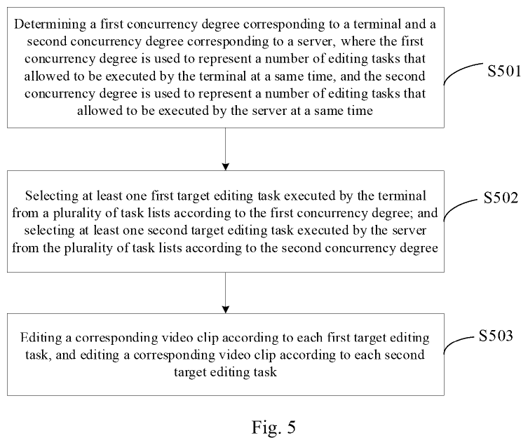

FIG. 5 is a flowchart of another method for video editing provided by an embodiment of the present disclosure. In this embodiment, based on the embodiment of FIG. 2 above, the step of editing the video clip according to the execution sequence of each editing task in the task list in step S204 will be further described. When there is one task list, the execution sequence corresponding to the task list may be directly executed. When there are multiple task lists, an editing task may be selected from the multiple task lists in turn through topological sorting for execution.

In an embodiment of the present disclosure, there are multiple task lists, and one task list corresponds to one video clip. Accordingly, the step of editing the video clip according to each of the editing tasks in the task list includes:

S501, determining a first concurrency degree corresponding to a terminal and a second concurrency degree corresponding to a server, where the first concurrency degree is used to represent a number of editing tasks that allowed to be executed by the terminal at a same time, and the second concurrency degree is used to represent a number of editing tasks that allowed to be executed by the server at a same time.

The editing task may be executed at the terminal or at the server. In some embodiments, an execution body of the editing task may be divided according to a task identification. Exemplarily, the execution body of the task identifications “reverse playing”, “slow motion”, “keying”, “anti-shaking”, “frame interpolation”, “stroboscopic effect removing”, “noise reduction” and “freezing” is the terminal. The execution body of the task identifications “lyrics recognition” and “server gameplay” is the server.

Accordingly, the step of determining the first concurrency degree corresponding to the terminal and the second concurrency degree corresponding to the server is: acquiring performance information, a CPU usage rate and a memory usage rate of the terminal, and determining the first concurrency degree corresponding to the terminal according to the performance information, the CPU usage rate and the memory usage rate of the terminal; and acquiring the number of editing tasks to be processed of the server and a rate at which the server processes the editing tasks, and determining the second concurrency degree corresponding to the server according to the number of editing tasks to be processed of the server and the rate at which the server processes the editing tasks. Optionally, the first concurrency degree may be represented by C₁, and the second concurrency degree may be represented by C_{S}.

In the embodiment of the present disclosure, the performance information of the terminal may include any parameter that represents the running capability of the terminal. Optionally, the performance information of the terminal includes one or more of a main frequency parameter of a CPU of the terminal and a memory capacity of the terminal. There is an association among the first concurrency degree, the performance information, the CPU usage rate and the memory usage rate, and the current first concurrency degree may be determined through the association. Exemplarily, the performance information of the terminal is: 2.4 GHZ, 8 GB in sequence; the CPU usage rate is 50%, the memory usage rate is 50%, and the first concurrency degree C₁ associated with the terminal performance information 2.4 GHZ, 8 GB, the CPU usage rate of 50% and the memory usage rate of 50% is: 1.

There is an association among the second concurrency degree, the number of editing tasks to be processed and the rate at which the server processes the editing tasks, and the current second concurrency degree may be determined through the association. Exemplarily, the number of editing tasks to be processed is 100, the rate at which the server processes the editing tasks is 100/s, and the second concurrency degree C_{S} associated with 100 and 100/s is: 5.

S502, selecting at least one first target editing task executed by the terminal from a plurality of task lists according to the first concurrency degree; and selecting at least one second target editing task executed by the server from the plurality of task lists according to the second concurrency degree.

Optionally, the step of selecting at least one first target editing task executed by the terminal from the multiple task lists according to the first concurrency degree is: selecting at least one target task list from the multiple task lists for which an editing task has not been executed; if the number of the first concurrency degree is less than or equal to the number of the at least one target task list, selecting, from the at least one target task list, the same number of first target editing tasks as the number of the first concurrency degree according to an adding time sequence of the at least one target task list; and if the number of the first concurrency degree is greater than the number of the at least one target task list, selecting one first target editing task from each target task list.

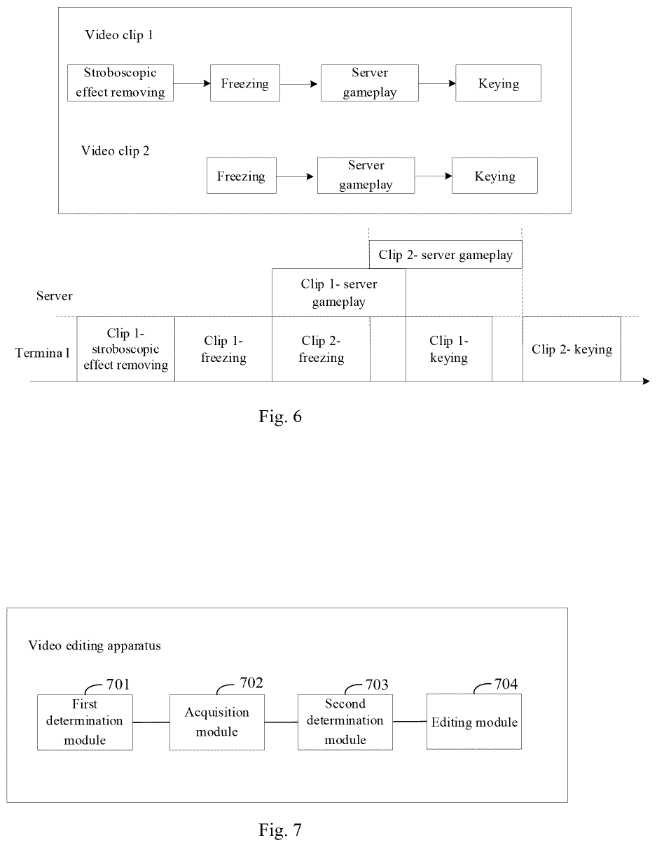

Exemplarily, as shown in FIG. 6, two target task lists for which an editing task has not been executed are selected from the multiple task lists: a task list corresponding to a video clip 1 and a task list corresponding to a video clip 2. The task list corresponding to the video clip 1 is: stroboscopic effect removing→freezing→server gameplay→keying, and the task list corresponding to the video clip 2 is: freezing→server gameplay→keying. The task list corresponding to the video clip 1 is added before the task list corresponding to the video clip 2.

Exemplarily, as shown in FIG. 6, the first concurrency degree C corresponding to the terminal is:
1. The first concurrency degree is less than the number of target task lists. In this case, according to the adding sequence of the at least one target task list, the first target editing task selected from the task list corresponding to the video clip 1 that is the same as the first concurrency degree (C₁ is 1) is: “stroboscopic effect removing” in the task list corresponding to the video clip 1.

Exemplarily, as shown in FIG. 6, after the execution of the “stroboscopic effect removing” of the video clip 1 is completed, the first target editing task the same as the first concurrency degree (C₁ is 1) is selected again from the target task list for which the terminal editing task has not been executed. At this time, the first target editing task is: “freezing” in the task list corresponding to the video clip 1.

Exemplarily, as shown in FIG. 6, after the execution of the “freezing” of the video clip 1 is completed, the first target editing task the same as the first concurrency degree (C₁ is 1) is selected again from the target task list for which the terminal editing task has not been executed. At this time, the first target editing task is: “freezing” in the task list corresponding to the video clip 2.

Exemplarily, as shown in FIG. 6, after the execution of the “freezing” of the video clip 2 is completed, the first target editing task the same as the first concurrency degree (C₁ is 1) is selected again from the target task list for which the terminal editing task has not been executed. At this time, the first target editing task is: “keying” in the task list corresponding to the video clip 1.

Exemplarily, as shown in FIG. 6, after the execution of the “keying” of the video clip 1 is completed, the first target editing task the same as the first concurrency degree (C₁ is 1) is selected again from the target task list for which the terminal editing task has not been executed. At this time, the first target editing task is: “keying” in the task list corresponding to the video clip 2.

Optionally, the step of selecting at least one second target editing task executed by the server from the multiple task lists according to the second concurrency degree is: selecting at least one target task list from the multiple task lists for which an editing task has not been executed; if the number of the second concurrency degree is less than or equal to the number of the at least one target task list, selecting, from the at least one target task list, the same number of second target editing tasks as the number of the second concurrency degree according to an adding time sequence of the at least one target task list; and if the number of the second concurrency degree is greater than the number of the at least one target task list, selecting one second target editing task executed by the server from each target task list.

Exemplarily, as shown in FIG. 6, the second concurrency degree Cs corresponding to the server is: 5. The first concurrency degree is greater than the number of target task lists. In this case, one second target editing task executed by the server is selected from each target task list: “server gameplay” in the task list corresponding to the video clip 1 and “server gameplay” in the task list corresponding to the video clip 2.

S503, editing a corresponding video clip according to each first target editing task, and editing a corresponding video clip according to each second target editing task.

Here, when multiple video clips are edited according to the task list, the editing tasks of the multiple video clips may be processed in parallel according to the concurrency degree, thus the execution time of the multiple editing tasks is shortened, further improving the efficiency of editing the video.

In an embodiment of the present disclosure, number information of editing tasks and progress information corresponding to each editing task are further displayed in the video editing interface. Exemplarily, the number information of the editing tasks includes: 2 tasks in progress; and the progress information corresponding to each editing task includes: noise reduction 12%, stroboscopic effect removing 0%. Here, by displaying the progress information corresponding to each editing task, the waiting anxiety of the user may be relieved, thus improving the user experience.

In an embodiment of the present disclosure, the progress information corresponding to each editing task may be displayed in the form of a floating box. Accordingly, a control button corresponding to the floating box is further displayed in the video editing interface, and the floating box is displayed or hidden in response to a trigger operation on the control button. Optionally, the control button may be located on one side of the number information of the editing tasks. The present application does not specifically limit the style of the control button.

In an embodiment of the present disclosure, a close button corresponding to each editing task is further displayed in the video editing interface, and the editing task corresponding to the close button is cancelled in response to a trigger operation on the close button. Here, the corresponding editing task may be cancelled through the close button, which improves the flexibility of the method for video editing and further improves the user experience.

FIG. 7 is a structural block diagram of a video editing apparatus provided by an embodiment of the present disclosure. Referring to FIG. 7, the video editing apparatus includes: a first determination module 701, an acquisition module 702, a second determination module 703 and an editing module 704.

The first determination module 701 is configured to determine a video clip corresponding to an editing task to be added and category information corresponding to the editing task to be added in response to receiving the editing task to be added;
the acquisition module 702 is configured to acquire a task list corresponding to the video clip, where the task list includes at least one added editing task;
the second determination module 703 is configured to determine category information corresponding to the added editing task, and determine an execution sequence of the editing task to be added and the added editing task according to the category information corresponding to the editing task to be added and the category information corresponding to the added editing task; and
the editing module 704 is configured to add the editing task to be added to the task list according to the execution sequence, and edit the video clip according to the execution sequence of each editing task in the task list.

According to one or more embodiments of the present disclosure, the second determination module 703 determines the execution sequence of the editing task to be added and the added editing task according to the category information corresponding to the editing task to be added and the category information corresponding to the added editing task, which specifically includes: determining an execution priority of each editing task according to the category information corresponding to the editing task to be added and the category information corresponding to the added editing task; and determining the execution sequence of the editing task to be added and the added editing task according to the execution priority of each editing task.

According to one or more embodiments of the present disclosure, the second determination module 703 determines the execution priority of each editing task according to the category information corresponding to the editing task to be added and the category information corresponding to the added editing task, which specifically includes: if the category information is a new video generation category, determining the execution priority of the editing task to be a first-level priority, and if the category information is an original video adjustment category, determining the execution priority of the editing task to be a second-level priority, where the new video generation category is used to represent that a new video clip is generated after editing the video clip through the editing task, and the original video adjustment category is used to represent that no new video clip is generated after editing the video clip through the editing task; and the first-level priority is higher than the second-level priority.

According to one or more embodiments of the present disclosure, the second determination module 703 determines the execution sequence of the editing task to be added and the added editing task according to the execution priority of each editing task, which specifically includes: setting the execution sequence of the editing task whose execution priority is the first-level priority before the execution sequence of the editing task whose execution priority is the second-level priority; if there are multiple editing tasks whose execution priority is the first-level priority, acquiring the adding time of each editing task whose execution priority is the first-level priority, and determining the execution sequence of the multiple editing tasks whose execution priority is the first-level priority according to the sequence of the adding time of the editing tasks; and/or if there are multiple editing tasks whose execution priority is the second-level priority, acquiring the adding time of each editing task whose execution priority is the second-level priority, and determining the execution sequence of the multiple editing tasks whose execution priority is the second-level priority according to the sequence of the adding time of the editing tasks.

According to one or more embodiments of the present disclosure, the apparatus further includes: an adding module, and the adding module is configured to: acquire a historical editing task that has been executed on the video clip, and determine whether there is a coupling relationship between the editing task to be added and the historical editing task, where the coupling relationship is used to represent that the editing task to be added will change the editing effect of the historical editing task; and if there is the coupling relationship between the editing task to be added and the historical editing task, add the historical editing task to the task list again.

According to one or more embodiments of the present disclosure, the second determination module 703 is further configured to: if there are multiple video clips corresponding to the editing task to be added, take the editing task to be added as an initial editing task in the task list or take the editing task to be added as a separate editing task, where the execution priority of the separate editing task is greater than the execution priority of an editing task in the task list.

According to one or more embodiments of the present disclosure, the editing module 704 adds the editing task to be added to the task list according to the execution sequence, which specifically includes: querying whether there is a target editing task whose execution sequence has a binding relationship with the execution sequence of the editing task to be added in the at least one added editing task included in the task list; and if there is the target editing task, adding the editing task to be added to an adjacent position of the target editing task according to the execution sequence indicated in the binding relationship.

According to one or more embodiments of the present disclosure, there are multiple task lists, and one task list corresponds to one video clip. Accordingly, the editing module 704 edits the video clip according to the execution sequence of each editing task in the task list, which specifically includes: determining a first concurrency degree corresponding to a terminal and a second concurrency degree corresponding to a server, where the first concurrency degree is used to represent the number of editing tasks that may be executed by the terminal at the same time, and the second concurrency degree is used to represent the number of editing tasks that may be executed by the server at the same time; selecting at least one first target editing task executed by the terminal from the multiple task lists according to the first concurrency degree; and selecting at least one second target editing task executed by the server from the multiple task lists according to the second concurrency degree; and editing the corresponding video clip according to each first target editing task, and editing the corresponding video clip according to each second target editing task.

According to one or more embodiments of the present disclosure, the editing module 704 determines the first concurrency degree corresponding to the terminal and the second concurrency degree corresponding to the server, which specifically includes: acquiring performance information, a CPU usage rate and a memory usage rate of the terminal, and determining the first concurrency degree corresponding to the terminal according to the performance information, the CPU usage rate and the memory usage rate of the terminal; and acquiring the number of editing tasks to be processed of the server and a rate at which the server processes the editing tasks, and determining the second concurrency degree corresponding to the server according to the number of editing tasks to be processed of the server and the rate at which the server processes the editing tasks.

According to one or more embodiments of the present disclosure, the editing module 704 selects at least one first target editing task executed by the terminal from the multiple task lists according to the first concurrency degree, which specifically includes: selecting at least one target task list from the multiple task lists for which an editing task has not been executed; if the number of the first concurrency degree is less than or equal to the number of the at least one target task list, selecting, from the at least one target task list, the same number of first target editing tasks as the number of the first concurrency degree according to an adding time sequence of the at least one target task list; and if the number of the first concurrency degree is greater than the number of the at least one target task list, selecting one first target editing task from each target task list.

According to one or more embodiments of the present disclosure, the editing module 704 selects at least one second target editing task executed by the server from the multiple task lists according to the second concurrency degree, which specifically includes: selecting at least one target task list from the multiple task lists for which an editing task has not been executed; if the number of the second concurrency degree is less than or equal to the number of the at least one target task list, selecting, from the at least one target task list, the same number of second target editing tasks as the number of the second concurrency degree according to an adding time sequence of the at least one target task list; and if the number of the second concurrency degree is greater than the number of the at least one target task list, selecting one second target editing task executed by the server from each target task list.

The first determination module 701, the acquisition module 702, the second determination module 703 and the editing module 704 are connected in sequence. The video editing apparatus provided by this embodiment may execute the technical solutions of the above method embodiments, and the implementation principles and technical effects thereof are similar, which will not be repeated here in this embodiment.

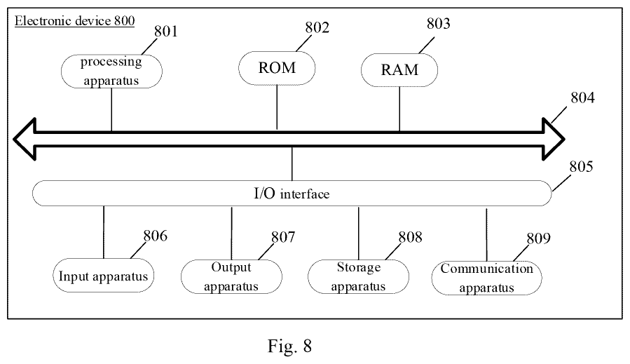

Referring to FIG. 8, which shows a schematic structural diagram of an electronic device 800 suitable for implementing the embodiments of the present disclosure, the electronic device 800 may be a terminal device or a server. The terminal device may include, but is not limited to, mobile terminals such as a mobile phone, a laptop, a digital broadcast receiver, a personal digital assistant (abbreviated as PDA), a tablet computer, a portable media player (abbreviated as PMP), a vehicle-mounted terminal (e.g., a vehicle navigation terminal), etc., and stationary terminals such as a digital TV, a desktop computer, etc. The electronic device shown in FIG. 8 is only an example, and should not impose any limitation on the function and scope of use of the embodiments of the present disclosure.

As shown in FIG. 8, the electronic device 800 may include a processing apparatus 801 (e.g., a central processing unit, a graphics processor, etc.), which may perform various appropriate actions and processing according to a program stored in a read-only memory (abbreviated as ROM) 802 or a program loaded from a storage apparatus 808 into a random access memory (abbreviated as RAM) 803. In the RAM 803, various programs and data required for the operation of the electronic device 800 are also stored. The processing apparatus 801, the ROM 802 and the RAM 803 are connected to each other through a bus 804. An input/output (I/O) interface 805 is also connected to the bus 804.

Usually, the following apparatus may be connected to the I/O interface 805: an input apparatus 806 including, for example, a touch screen, a touchpad, a keyboard, a mouse, a camera, a microphone, an accelerometer, a gyroscope, etc.; an output apparatus 807 including, for example, a liquid crystal display (abbreviated as LCD), a speaker, a vibrator, etc.; a storage apparatus 808 including, for example, a magnetic tape, a hard disk, etc.; and a communication apparatus 809. The communication apparatus 809 may allow the electronic device 800 to perform wireless or wired communication with other devices to exchange data. Although FIG. 8 shows the electronic device 800 having various apparatuses, it should be understood that it is not required to implement or have all the apparatuses shown. Alternatively, more or fewer apparatuses may be implemented or provided.

In particular, according to the embodiments of the present disclosure, the process described above with reference to the flowchart may be implemented as a computer software program. For example, the embodiments of the present disclosure include a computer program product, which includes a computer program carried on a computer-readable medium, and the computer program contains program code for executing the method shown in the flowchart. In such an embodiment, the computer program may be downloaded and installed from a network through the communication apparatus 809, or installed from the storage apparatus 808, or installed from the ROM 802. When the computer program is executed by the processing apparatus 801, the above-mentioned functions defined in the methods of the embodiments of the present disclosure are executed.

It should be noted that the above-mentioned computer-readable medium in the present disclosure may be a computer-readable signal medium, a computer-readable storage medium, or any combination thereof. The computer-readable storage medium may be, for example, but not limited to, an electrical, magnetic, optical, electromagnetic, infrared, or semiconductor system, apparatus or device, or any combination thereof. More specific examples of the computer-readable storage medium may include, but are not limited to: an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the above. In the present disclosure, a computer-readable storage medium may be any tangible medium that contains or stores a program, which may be used by or in combination with an instruction execution system, apparatus or device. In the present disclosure, a computer-readable signal medium may include a data signal propagated in a baseband or as a part of a carrier wave, and computer-readable program code is carried in the data signal. This propagated data signal may take many forms, including but not limited to an electromagnetic signal, an optical signal, or any suitable combination of the above. The computer-readable signal medium may also be any computer-readable medium other than the computer-readable storage medium, and the computer-readable signal medium may send, propagate or transmit the program used by or in combination with the instruction execution system, apparatus or device. The program code contained on the computer-readable medium may be transmitted by any suitable medium, including but not limited to: a wire, an optical cable, a radio frequency (RF), etc., or any suitable combination of the above.

The above computer-readable medium may be included in the above electronic device, or it may exist alone without being assembled into the electronic device.

The above computer-readable medium carries one or more programs, and when the above one or more programs are executed by the electronic device, the electronic device is caused to execute the method shown in the above embodiment.

The computer program code for executing the operations of the present disclosure may be written in one or more programming languages or a combination thereof, where the above programming languages include object-oriented programming languages such as Java, Smalltalk, C++, and also include conventional procedural programming languages such as “C” language or similar programming languages. The program code may be executed entirely on a user's computer, partly on a user's computer, as a stand-alone software package, partly on a user's computer and partly on a remote computer, or entirely on a remote computer or server. In the case of involving a remote computer, the remote computer may be connected to a user's computer through any kind of network, including a local area network (Local Area Network, LAN for short) or a wide area network (Wide Area Network, WAN for short), or it may be connected to an external computer (for example, connected by using Internet provided by an Internet service provider).

The flowcharts and block diagrams in the drawings illustrate the possibly implemented architectures, functions and operations of the system, method and computer program product according to various embodiments of the present disclosure. In this regard, each block in the flowchart or block diagram may represent a module, program segment, or part of code, which contains one or more executable instructions for implementing the specified logical functions. It should also be noted that, in some alternative implementations, the functions marked in the blocks may also occur in an order different from that marked in the drawings. For example, two blocks shown in succession may actually be executed substantially in parallel, or they may sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The involved units described in the embodiments of the present disclosure may be implemented by software or by hardware. Among them, the name of a unit does not constitute a limitation on the unit itself under certain circumstances, for example, the first acquisition unit may also be described as “a unit that acquires at least two internet protocol addresses”.

The functions described above herein may be performed at least partly by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logical device (CPLD) and more.

In the context of the present disclosure, a machine-readable medium may be a tangible medium that may contain or store programs for use by or in combination with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium will include an electrical connection based on one or more lines, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

In a first aspect, according to one or more embodiments of the present disclosure, a method for video editing is provided, which includes:
determining a video clip corresponding to an editing task to be added and category information corresponding to the editing task to be added in response to receiving the editing task to be added;
acquiring a task list corresponding to the video clip, where the task list includes at least one added editing task;
determining category information corresponding to the added editing task, and determining an execution sequence of the editing task to be added and the added editing task according to the category information corresponding to the editing task to be added and the category information corresponding to the added editing task; and
adding the editing task to be added to the task list according to the execution sequence, and editing the video clip according to the execution sequence of each editing task in the task list.

According to one or more embodiments of the present disclosure, the determining the execution sequence of the editing task to be added and the added editing task according to the category information corresponding to the editing task to be added and the category information corresponding to the added editing task includes: determining an execution priority of each editing task according to the category information corresponding to the editing task to be added and the category information corresponding to the added editing task; and determining the execution sequence of the editing task to be added and the added editing task according to the execution priority of each editing task.

According to one or more embodiments of the present disclosure, the determining the execution priority of each editing task according to the category information corresponding to the editing task to be added and the category information corresponding to the added editing task includes: if the category information is a new video generation category, determining the execution priority of the editing task to be a first-level priority, and if the category information is an original video adjustment category, determining the execution priority of the editing task to be a second-level priority, where the new video generation category is used to represent that a new video clip is generated after editing the video clip through the editing task, and the original video adjustment category is used to represent that no new video clip is generated after editing the video clip through the editing task; and the first-level priority is higher than the second-level priority.

According to one or more embodiments of the present disclosure, the determining the execution sequence of the editing task to be added and the added editing task according to the execution priority of each editing task includes: setting the execution sequence of the editing task whose execution priority is the first-level priority before the execution sequence of the editing task whose execution priority is the second-level priority; if there are multiple editing tasks whose execution priority is the first-level priority, acquiring the adding time of each editing task whose execution priority is the first-level priority, and determining the execution sequence of the multiple editing tasks whose execution priority is the first-level priority according to the sequence of the adding time of the editing tasks; and/or if there are multiple editing tasks whose execution priority is the second-level priority, acquiring the adding time of each editing task whose execution priority is the second-level priority, and determining the execution sequence of the multiple editing tasks whose execution priority is the second-level priority according to the sequence of the adding time of the editing tasks.

According to one or more embodiments of the present disclosure, after the adding the editing task to be added to the task list according to the execution sequence, the method further includes: acquiring a historical editing task that has been executed on the video clip, and determining whether there is a coupling relationship between the editing task to be added and the historical editing task, where the coupling relationship is used to represent that the editing task to be added will change the editing effect of the historical editing task; and if there is the coupling relationship between the editing task to be added and the historical editing task, re-adding the historical editing task to the task list.

According to one or more embodiments of the present disclosure, before the acquiring the task list corresponding to the video clip, the method further includes: if there are multiple video clips corresponding to the editing task to be added, taking the editing task to be added as an initial editing task in the task list or taking the editing task to be added as a separate editing task, where the execution priority of the separate editing task is greater than the execution priority of an editing task in the task list.

According to one or more embodiments of the present disclosure, the adding the editing task to be added to the task list according to the execution sequence includes: querying whether there is a target editing task whose execution sequence has a binding relationship with the execution sequence of the editing task to be added in the at least one added editing task included in the task list; and if there is the target editing task, adding the editing task to be added to an adjacent position of the target editing task according to the execution sequence indicated in the binding relationship.

According to one or more embodiments of the present disclosure, there are multiple task lists, and one task list corresponds to one video clip. Accordingly, the editing the video clip according to the execution sequence of each editing task in the task list includes: determining a first concurrency degree corresponding to a terminal and a second concurrency degree corresponding to a server, where the first concurrency degree is used to represent the number of editing tasks that may be executed by the terminal at the same time, and the second concurrency degree is used to represent the number of editing tasks that may be executed by the server at the same time; selecting at least one first target editing task executed by the terminal from the multiple task lists according to the first concurrency degree; and selecting at least one second target editing task executed by the server from the multiple task lists according to the second concurrency degree; and editing the corresponding video clip according to each first target editing task, and editing the corresponding video clip according to each second target editing task.

According to one or more embodiments of the present disclosure, the determining the first concurrency degree corresponding to the terminal and the second concurrency degree corresponding to the server includes: acquiring performance information, a CPU usage rate and a memory usage rate of the terminal, and determining the first concurrency degree corresponding to the terminal according to the performance information, the CPU usage rate and the memory usage rate of the terminal; and acquiring the number of editing tasks to be processed of the server and a rate at which the server processes the editing tasks, and determining the second concurrency degree corresponding to the server according to the number of editing tasks to be processed of the server and the rate at which the server processes the editing tasks.

According to one or more embodiments of the present disclosure, the selecting at least one first target editing task executed by the terminal from the multiple task lists according to the first concurrency degree includes: selecting at least one target task list from the multiple task lists for which an editing task has not been executed; if the number of the first concurrency degree is less than or equal to the number of the at least one target task list, selecting, from the at least one target task list, the same number of first target editing tasks as the number of the first concurrency degree according to an adding time sequence of the at least one target task list; and if the number of the first concurrency degree is greater than the number of the at least one target task list, selecting one first target editing task from each target task list.

According to one or more embodiments of the present disclosure, the selecting at least one second target editing task executed by the server from the multiple task lists according to the second concurrency degree includes: selecting at least one target task list from the multiple task lists for which an editing task has not been executed; if the number of the second concurrency degree is less than or equal to the number of the at least one target task list, selecting, from the at least one target task list, the same number of second target editing tasks as the number of the second concurrency degree according to an adding time sequence of the at least one target task list; and if the number of the second concurrency degree is greater than the number of the at least one target task list, selecting one second target editing task executed by the server from each target task list.

In a second aspect, according to one or more embodiments of the present disclosure, a video editing apparatus is provided, which includes:
a first determination module, configured to determine a video clip corresponding to an editing task to be added and category information corresponding to the editing task to be added in response to receiving the editing task to be added;
an acquisition module, configured to acquire a task list corresponding to the video clip, where the task list includes at least one added editing task;
a second determination module, configured to determine category information corresponding to the added editing task, and determine an execution sequence of the editing task to be added and the added editing task according to the category information corresponding to the editing task to be added and the category information corresponding to the added editing task; and
an editing module, configured to add the editing task to be added to the task list according to the execution sequence, and edit the video clip according to the execution sequence of each editing task in the task list.

According to one or more embodiments of the present disclosure, the second determination module determines the execution sequence of the editing task to be added and the added editing task according to the category information corresponding to the editing task to be added and the category information corresponding to the added editing task, which specifically includes: determining an execution priority of each editing task according to the category information corresponding to the editing task to be added and the category information corresponding to the added editing task; and determining the execution sequence of the editing task to be added and the added editing task according to the execution priority of each editing task.

According to one or more embodiments of the present disclosure, the second determination module determines the execution priority of each editing task according to the category information corresponding to the editing task to be added and the category information corresponding to the added editing task, which specifically includes: if the category information is a new video generation category, determining the execution priority of the editing task to be a first-level priority, and if the category information is an original video adjustment category, determining the execution priority of the editing task to be a second-level priority, where the new video generation category is used to represent that a new video clip is generated after editing the video clip through the editing task, and the original video adjustment category is used to represent that no new video clip is generated after editing the video clip through the editing task; and the first-level priority is higher than the second-level priority.

According to one or more embodiments of the present disclosure, the second determination module determines the execution sequence of the editing task to be added and the added editing task according to the execution priority of each editing task, which specifically includes: setting the execution sequence of the editing task whose execution priority is the first-level priority before the execution sequence of the editing task whose execution priority is the second-level priority; if there are multiple editing tasks whose execution priority is the first-level priority, acquiring the adding time of each editing task whose execution priority is the first-level priority, and determining the execution sequence of the multiple editing tasks whose execution priority is the first-level priority according to the sequence of the adding time of the editing tasks; and/or if there are multiple editing tasks whose execution priority is the second-level priority, acquiring the adding time of each editing task whose execution priority is the second-level priority, and determining the execution sequence of the multiple editing tasks whose execution priority is the second-level priority according to the sequence of the adding time of the editing tasks.

According to one or more embodiments of the present disclosure, the apparatus further includes: an adding module, and the adding module is configured to: acquire a historical editing task that has been executed on the video clip, and determine whether there is a coupling relationship between the editing task to be added and the historical editing task, where the coupling relationship is used to represent that the editing task to be added will change the editing effect of the historical editing task; and if there is the coupling relationship between the editing task to be added and the historical editing task, add the historical editing task to the task list again.

According to one or more embodiments of the present disclosure, the second determination module is further configured to: if there are multiple video clips corresponding to the editing task to be added, take the editing task to be added as an initial editing task in the task list or take the editing task to be added as a separate editing task, where the execution priority of the separate editing task is greater than the execution priority of an editing task in the task list.

According to one or more embodiments of the present disclosure, the editing module adds the editing task to be added to the task list according to the execution sequence, which specifically includes: querying whether there is a target editing task whose execution sequence has a binding relationship with the execution sequence of the editing task to be added in the at least one added editing task included in the task list; and if there is the target editing task, adding the editing task to be added to an adjacent position of the target editing task according to the execution sequence indicated in the binding relationship.

According to one or more embodiments of the present disclosure, there are multiple task lists, and one task list corresponds to one video clip. Accordingly, the editing module edits the video clip according to the execution sequence of each editing task in the task list, which specifically includes: determining a first concurrency degree corresponding to a terminal and a second concurrency degree corresponding to a server, where the first concurrency degree is used to represent the number of editing tasks that may be executed by the terminal at the same time, and the second concurrency degree is used to represent the number of editing tasks that may be executed by the server at the same time; selecting at least one first target editing task executed by the terminal from the multiple task lists according to the first concurrency degree; and selecting at least one second target editing task executed by the server from the multiple task lists according to the second concurrency degree; and editing the corresponding video clip according to each first target editing task, and editing the corresponding video clip according to each second target editing task.

According to one or more embodiments of the present disclosure, the editing module determines the first concurrency degree corresponding to the terminal and the second concurrency degree corresponding to the server, which specifically includes: acquiring performance information, a CPU usage rate and a memory usage rate of the terminal, and determining the first concurrency degree corresponding to the terminal according to the performance information, the CPU usage rate and the memory usage rate of the terminal; and acquiring the number of editing tasks to be processed of the server and a rate at which the server processes the editing tasks, and determining the second concurrency degree corresponding to the server according to the number of editing tasks to be processed of the server and the rate at which the server processes the editing tasks.

According to one or more embodiments of the present disclosure, the editing module selects at least one first target editing task executed by the terminal from the multiple task lists according to the first concurrency degree, which specifically includes: selecting at least one target task list from the multiple task lists for which an editing task has not been executed; if the number of the first concurrency degree is less than or equal to the number of the at least one target task list, selecting, from the at least one target task list, the same number of first target editing tasks as the number of the first concurrency degree according to an adding time sequence of the at least one target task list; and if the number of the first concurrency degree is greater than the number of the at least one target task list, selecting one first target editing task from each target task list.

According to one or more embodiments of the present disclosure, the editing module selects at least one second target editing task executed by the server from the multiple task lists according to the second concurrency degree, which specifically includes: selecting at least one target task list from the multiple task lists for which an editing task has not been executed; if the number of the second concurrency degree is less than or equal to the number of the at least one target task list, selecting, from the at least one target task list, the same number of second target editing tasks as the number of the second concurrency degree according to an adding time sequence of the at least one target task list; and if the number of the second concurrency degree is greater than the number of the at least one target task list, selecting one second target editing task executed by the server from each target task list.

In a third aspect, according to one or more embodiments of the present disclosure, an electronic device is provided, which includes: a processor, and a memory communicatively connected to the processor;
where the memory stores computer-executable instructions; and
the processor executes the computer-executable instructions stored in the memory to implement the method for video editing according to the first aspect above and various possible designs of the first aspect.

In a fourth aspect, according to one or more embodiments of the present disclosure, a computer-readable storage medium is provided, where computer-executable instructions are stored in the computer-readable storage medium, and when the computer-executable instructions are executed by a processor, the method for video editing according to the first aspect above and various possible designs of the first aspect is implemented.

In a fifth aspect, an embodiment of the present disclosure provides a computer program product, which includes a computer program, and when the computer program is executed by a processor, the method for video editing according to the first aspect above and various possible designs of the first aspect is implemented.

The above description is only preferred embodiments of the present disclosure and an explanation of the technical principles employed. Those skilled in the art should understand that the scope of disclosure involved in the present disclosure is not limited to the technical solutions formed by the specific combination of the above technical features, and should also cover, without departing from the above disclosed concept, other technical solutions formed by any combination of the above technical features or their equivalent features. For example, a technical solution formed by replacing the above features with technical features with similar functions disclosed in the present disclosure (but not limited thereto) is also included.

Additionally, although operations are depicted in a particular order, it should not be understood that these operations are required to be performed in a specific order as illustrated or in a sequential order. Under certain circumstances, multitasking and parallel processing may be advantageous. Likewise, although the above discussion includes several specific implementation details, these should not be interpreted as limitations on the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in language specific to structural features and/or logical actions of the method, it should be understood that the subject matter defined in the appended claims is not necessarily limited to the specific features or actions described above. Rather, the specific features and actions described above are merely example forms of implementing the claims.

1. A method for video editing, comprising:
determining a video clip corresponding to an editing task to be added and category information corresponding to the editing task to be added in response to receiving the editing task to be added;
acquiring a task list corresponding to the video clip, wherein the task list comprises at least one added editing task;
determining category information corresponding to the added editing task, and determining an execution sequence of the editing task to be added and the added editing task according to the category information corresponding to the editing task to be added and the category information corresponding to the added editing task; and
adding the editing task to be added to the task list according to the execution sequence, and editing the video clip according to an execution sequence of each editing task in the task list.

2. The method of claim 1, wherein the determining an execution sequence of the editing task to be added and the added editing task according to the category information corresponding to the editing task to be added and the category information corresponding to the added editing task comprises:
determining an execution priority of each editing task according to the category information corresponding to the editing task to be added and the category information corresponding to the added editing task; and
determining the execution sequence of the editing task to be added and the added editing task according to the execution priority of each editing task.

3. The method of claim 2, wherein the determining an execution priority of each editing task according to the category information corresponding to the editing task to be added and the category information corresponding to the added editing task comprises:
in response to the category information being a new video generation category, determining the execution priority of the editing task to be a first-level priority, and in response to the category information being an original video adjustment category, determining the execution priority of the editing task to be a second-level priority, wherein the new video generation category is used to represent that a new video clip is generated after editing the video clip through the editing task, and the original video adjustment category is used to represent that no new video clip is generated after editing the video clip through the editing task, and
wherein the first-level priority is higher than the second-level priority.

4. The method of claim 2 or 3, wherein the determining the execution sequence of the editing task to be added and the added editing task according to the execution priority of each editing task comprises:
setting an execution sequence of an editing task whose execution priority is a first-level priority before an execution sequence of an editing task whose execution priority is a second-level priority; and
in response to a number of editing tasks whose execution priority is the first-level priority being more than one, acquiring an adding time of each editing task whose execution priority is the first-level priority, and determining an execution sequence of a plurality of editing tasks whose execution priority is the first-level priority according to a sequence of the adding time of the editing tasks; and/or in response to a number of editing tasks whose execution priority is the second-level priority being more than one, acquiring an adding time of each editing task whose execution priority is the second-level priority, and determining an execution sequence of a plurality of editing tasks whose execution priority is the second-level priority according to a sequence of the adding time of the editing tasks.

5. The method of claim 1, wherein after the adding the editing task to be added to the task list according to the execution sequence, the method further comprises:
acquiring a historical editing task that has been executed on the video clip, and determining whether a coupling relationship between the editing task to be added and the historical editing task exists, wherein the coupling relationship is used to represent that the editing task to be added changes an editing effect of the historical editing task; and
in response to the coupling relationship between the editing task to be added and the historical editing task existing, re-adding the historical editing task to the task list.

6. The method of claim 1, wherein before the acquiring a task list corresponding to the video clip, the method further comprises:
in response to a number of video clips corresponding to the editing task to be added being more than one, determining the editing task to be added as an initial editing task in the task list or determining the editing task to be added as a separate editing task, wherein an execution priority of the separate editing task is greater than an execution priority of an editing task in the task list.

7. The method of claim 1, wherein the adding the editing task to be added to the task list according to the execution sequence comprises:
querying whether a target editing task whose execution sequence has a binding relationship with the execution sequence of the editing task to be added exists in the at least one added editing task comprised in the task list; and
in response to the target editing task existing, adding the editing task to be added into an adjacent position of the target editing task according to an execution sequence indicated by the binding relationship.

8. The method of claim 1, wherein a number of task lists is more than one, and one task list corresponds to one video clip;
the editing the video clip according to the execution sequence of each editing task in the task list comprises:
determining a first concurrency degree corresponding to a terminal and a second concurrency degree corresponding to a server, wherein the first concurrency degree is used to represent a number of editing tasks that allowed to be executed by the terminal at a same time, and the second concurrency degree is used to represent a number of editing tasks that allowed to be executed by the server at a same time;
selecting at least one first target editing task executed by the terminal from a plurality of task lists according to the first concurrency degree; and selecting at least one second target editing task executed by the server from the plurality of task lists according to the second concurrency degree; and
editing a corresponding video clip according to each first target editing task, and editing a corresponding video clip according to each second target editing task.

9. The method of claim 8, wherein the determining a first concurrency degree corresponding to a terminal and a second concurrency degree corresponding to a server, comprises:
acquiring performance information, a CPU usage rate and a memory usage rate of the terminal, and determining the first concurrency degree corresponding to the terminal according to the performance information, the CPU usage rate and the memory usage rate of the terminal; and
acquiring a number of editing tasks to be processed of the server and a rate at which the server processes the editing tasks, and determining the second concurrency degree corresponding to the server according to the number of editing tasks to be processed of the server and the rate at which the server processes the editing tasks.

10. The method of claim 8, wherein the selecting at least one first target editing task executed by the terminal from the plurality of task lists according to the first concurrency degree comprises:
selecting, from the plurality of task lists, at least one target task list for which no editing task is executed;
in response to a number of the first concurrency degree being less than or equal to a number of the at least one target task list, selecting, from the at least one target task list, a same number of first target editing tasks as the number of the first concurrency degree according to an adding time sequence of the at least one target task list; and
in response to the number of the first concurrency degree being greater than the number of the at least one target task list, selecting one first target editing task from each target task list.

11. The method of claim 8, wherein the selecting at least one second target editing task executed by the server from the plurality of task lists according to the second concurrency degree comprises:
selecting, from the plurality of task lists, at least one target task list for which no editing task is executed;
in response to a number of the second concurrency degree being less than or equal to a number of the at least one target task list, selecting, from the at least one target task list, a same number of second target editing tasks as the number of the second concurrency degree according to an adding time sequence of the at least one target task list; and
in response to the number of the second concurrency degree being greater than the number of the at least one target task list, selecting one second target editing task executed by the server from each target task list.

12. A video editing apparatus, comprising:
a first determination module, configured to determine a video clip corresponding to an editing task to be added and category information corresponding to the editing task to be added in response to receiving the editing task to be added;
an acquisition module, configured to acquire a task list corresponding to the video clip, wherein the task list comprises at least one added editing task;
a second determination module, configured to determine category information corresponding to the added editing task, and determine an execution sequence of the editing task to be added and the added editing task according to the category information corresponding to the editing task to be added and the category information corresponding to the added editing task; and
an editing module, configured to add the editing task to be added to the task list according to the execution sequence, and edit the video clip according to an execution sequence of each editing task in the task list.

13. An electronic device, comprising: a processor, and a memory communicatively connected to the processor,
wherein the memory stores computer-executable instructions; and
the processor executes the computer-executable instructions stored in the memory to implement the method for video editing of any one of claims 1 to 11.

14. A computer-readable storage medium, wherein computer-executable instructions are stored in the computer-readable storage medium, and when the computer-executable instructions are executed by a processor, the method for video editing of any one of claims 1 to 11 is implemented.

15. A computer program product, comprising a computer program, wherein the method for video editing of any one of claims 1 to 11 is implemented when the computer program is executed by a processor.
